(19) United States
(12) Patent Application Publication
(10) Pub. No.: US 2004/0205172 A1
(43) Pub. Date: Oct. 14, 2004

(54) Control point server system and method thereof enabling efficient access to home network devices

(75) Inventor: Doheon Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/777,730

(22) Filed: Feb. 13, 2004

(30) Foreign Application Priority Data
Feb. 18, 2003 (KR) 10-2003-0010099

(51) Int. Cl. G06F 15/177; G06F 15/16; H04L 12/28; H04L 12/56

(52) U.S. Cl. 709/222; 709/203; 370/908

(57) ABSTRACT

A control point server includes a CP stack module for sending a search message to the devices connected to a home network and parsing a response message received from a home network device; a description module for requesting a description of the device connected to the home network based on the parsed information transmitted from the CP stack module; and a component generation module for organizing a component, which describes the services of the device connected to the home network, based on the description requested by the description module. Accordingly, discovery and description processes for devices on a home network are managed by the control point server, and thus, efficient access to the devices on the home network is gained.

This application claims the priority of Korean Patent Application No. 10-2003-0010099 filed on Feb. 18, 2003, in the Korean Intellectual Property Office, the disclosure of which is incorporated herein in its entirety by reference.

### BACKGROUND OF THE INVENTION

1. Field of the Invention

The present invention relates to a control point server system and method thereof enabling efficient access to home network devices, and more particularly, to a control point server system and method thereof enabling efficient access to home network devices, wherein access to devices connected to a home network can be efficiently gained through a control point server.

2. Description of the Related Art

In general, a home network is configured using an Internet Protocol (hereinafter referred to as “IP”) based private network. Thus, various kinds of equipment used in the home, including all types of personal computers (PCs), intelligent appliances and wireless devices, are connected to one another and controlled through a single network.

A proposed home network system is configured in such a manner that a common virtual computing environment called middleware is established at the equipment residing on the private network and applications are provided on the computing environment. The middleware allows various kinds of equipment to communicate with one another in the home network. Currently available middleware includes home AV interoperability (HAVi), universal plug and play (UPnP), Jini, home wide web (HWW), and the like.

Various kinds of equipment residing on the home network are connected to one another in a peer-to-peer fashion through home network middleware. The respective equipment uses IP addresses that are assigned by a dynamic host configuration protocol (hereinafter, “DHCP”) server or selected by an auto IP function.

That is, when the respective equipment is first connected to the home network, it searches for the DHCP server in order to obtain the IP address assigned in accordance with a response of the DHCP server or automatically selects the IP address within a certain range using the auto IP function in the case of a network in which the DHCP server does not operate.

The equipment having an IP address assigned by the DHCP server or selected by the auto IP function can communicate with other equipment on the network using TCP/IP and perform searches and queries for the other equipment on the network via their respective IP addresses.

The home network middleware such as UPnP uses a protocol such as sampling stochastic dynamic programming (hereinafter, “SSDP”) in order to search for desired equipment in the home network. Further, in order to control the operation of the searched equipment, a web-based method is used in which a simple object access protocol (hereinafter, “SOAP”) is used to call a relevant control device or a control message is transmitted through a presentation web page.

FIGS. 4a-4c illustrate conventional control processes for controlling UPnP controlled devices residing on a home network. A UPnP home network primarily comprises an UPnP controlled device (hereinafter, referred to as “UPnP CD”) 20 to be subjected to control and an UPnP control point (hereinafter, referred to as “UPnP CP”) 10 for controlling the UPnP CD 20.

The UPnP CD 20 may include a plurality of UPnP devices, and each device may implement a specific service according to its own function. UPnP CP 10 controls the UPnP CD 20 by analyzing XML files in which specific services of the devices are described.

In such a conventional method, discovery, description and control processes should be performed to control UPnP controlled devices on the UPnP home network. Here, the UPnP CP 10 searches for a desired device to be controlled through the discovery process, reads and analyzes a service template XML file of the device, which has been searched for through the discovery process, to determine whether specific control commands can be sent to the device through the description process, and controls the UPnP device by sending a SOAP message to a specific service of the UPnP device to be controlled through the control process.

FIG. 4a is a diagram illustrating the discovery process. This process can be described in connection with two cases. One of these cases is a case where a new UPnP device enters the home network, and the other case is a case where a UPnP CP 10 enters the home network.

First, the case where a UPnP device (for example, UPnP CD 1) enters the network is called “advertising”. In this case, the UPnP device sends a multicast message about its existence to UPnP CPs 10. That is, when the UPnP device enters the network in which the UPnP CPs 10 exist, it sends a multicast message about its existence to all the devices or UPnP CPs 10 on the network after a unique URL is assigned thereto through an addressing process. A UPnP CP 10 that intends to control the UPnP device receives and registers the multicast message transmitted from the UPnP device.

On the contrary, in the case where an UPnP CP 10 enters the home network in which UPnP devices exist, if the UPnP CP 10 sends a multicast message, a desired UPnP device searched by the UPnP CP 10 sends a unicast message to the UPnP CP 10. That is, after being assigned a unique URL through the addressing process, the UPnP device sends a unicast response message to the multicast search message, which has been received from the UPnP CP 10, to the UPnP CP 10 that searches for the UPnP device. Then, the UPnP CP 10 that has received the response message registers the UPnP device.

FIG. 4b illustrates the description process in which the UPnP CP 10 acquires service functions required for controlling a UPnP device by analyzing a service description XML file provided by the relevant UPnP device. That is, a UPnP CP 10 that intends to control a UPnP device requests the UPnP device to send a description XML file and parses the requested description XML file.

FIG. 4c illustrates the control process in which the UPnP CP 10 sends a SOAP-message-format command to a specific service of a UPnP device to be controlled in a state where individual URL addresses are mutually recognized by the UPnP device and the UPnP CP 10 through the addressing and discovery processes. That is, the UPnP CP 10 can directly control a desired UPnP device by transmitting a service template for the UPnP device.

However, critical problems of the conventional home network technology are that the discovery and description processes require too much time and some UPnP devices may not be found during the discovery process.

For example, when a network client launches the UPnP CP 10 to control a UPnP device in the discovery process, the UPnP CP 10 sends a multicast message searching for the UPnP device. At this time, the UPnP device that has received the multicast message from the UPnP CP 10 should send a response message within a predetermined period of time. However, the transmission of the response message may be delayed due to traffic on the home network. Further, the UPnP CP 10 should parse and analyze a service template XML file for the device in order to utilize the service of the UPnP device. The time required for parsing and analysis varies according to service templates.

Moreover, although the UPnP device that has received the message from the UPnP CP 10 should send a response message within the predetermined period of time as described above, there may be occasional cases where the UPnP device cannot immediately send a response message due to a variety of reasons (e.g., traffic on the network, multicast capability or processing method of a wireless access point, and the like). Accordingly, there may be cases where the client cannot find a desired device to be controlled.

Thus, the UPnP CP 10 occasionally fails in its search for a desired UPnP device even when the UPnP device is connected to the home network. Further, even though the UPnP device is found, time spent in searching for the UPnP device gives users inconvenience.

### SUMMARY OF THE INVENTION

The present invention is conceived to solve the aforementioned problems. An exemplary object of the present invention is to provide a control point server system and method thereof enabling efficient access to home network devices, wherein discovery and description processes for the home network devices are managed by a control point server (hereinafter, referred to as “CP server”), thereby gaining efficient access to the devices on the home network.

Another exemplary object of the present invention is to provide a control point server system and method thereof enabling efficient access to home network devices, wherein a CP server, containing service components of the devices on a home network, is provided to gain quick access to a relevant home network device when a user requests control of the device.

According to an illustrative aspect of the present invention for achieving the aforementioned exemplary objects, there is provided a control point server, comprising a CP stack module for sending a search message to the devices connected to the home network and parsing a response message received from a home network device; a description module for requesting a description of the device connected to the home network, based on the parsed information received from the CP stack module; and a component generation module for organizing a service component that describes services provided by the device connected to the home network based on the description requested by the description module.

In addition, according to another illustrative aspect of the present invention, there is provided a method for a control point server system enabling efficient access to home network devices, comprising the steps of requesting a search for a device on a home network; multicasting a search message for the device on the home network, according to the search request for the home network device; receiving a response message to the search message, and parsing and transmitting the received response message; requesting a description of the home network device based on the parsed and transmitted information; organizing a component that describes services of the home network device based on the requested description of the home network device; and storing information on the organized component in a predetermined lookup table.

### BRIEF DESCRIPTION OF THE DRAWINGS

The above and other exemplary objects and features of the present invention will become apparent from the following description of illustrative, non-limiting embodiments given in conjunction with the accompanying drawings, in which:

FIG. 1 is a schematic block diagram of a control point server system enabling efficient access to home network devices according to the present invention;

FIG. 2 is a flowchart schematically illustrating a method for a control point server system enabling efficient access to home network devices according to the present invention;

FIG. 3 is a diagram illustrating an example of services which a home network control point server provides to a control point in accordance with the present invention; and

FIGS. 4a-4c are diagrams showing conventional operating processes of controlling UPnP controlled devices on a home network.

### DETAILED DESCRIPTION OF THE INVENTION

Hereinafter, illustrative, non-limiting embodiments of the present invention will be explained in detail with reference to the accompanying drawings.

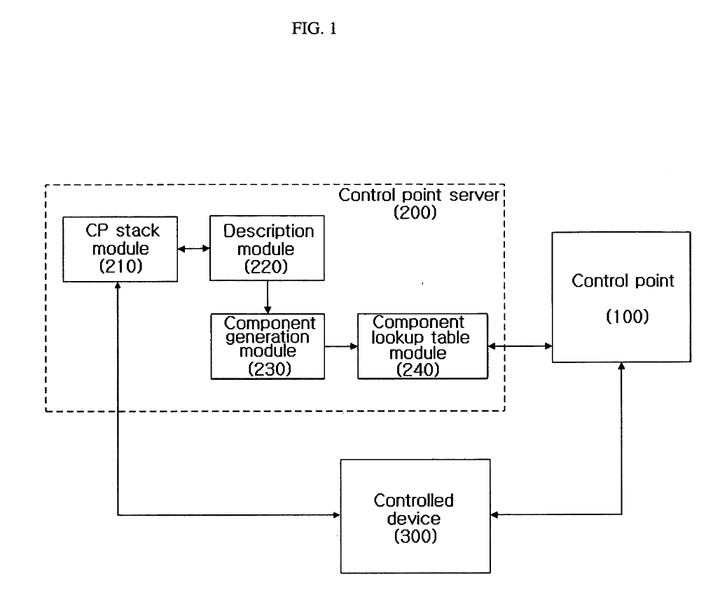

FIG. 1 is a block diagram schematically showing a control point server system enabling efficient access to home network devices according to the present invention. The system comprises a control point (hereinafter, referred to as “CP”) 100, a CP server 200 and a controlled device (hereinafter, referred to as “CD”) 300.

The CP 100 controls devices residing on the home network. That is, the CP 100 multicasts a search message searching for a desired device on the home network and controls the searched relevant device on the home network by receiving a service component of the relevant device from a control point server that organizes components of services of the devices residing on the home network. Further, the CP 100 multicasts a search message for searching for a desired device on the home network and controls the searched relevant device by receiving information on the relevant device from the controlled device that controls operations of respective devices. Here, if the CP 100 receives duplicate response messages from the CP server 200 and the CD 300, it does not process the later-received response message from either the CP server 200 or the CD 300.

The CP server 200 resides on the home network and performs discovery and description processes for the devices on the home network to organize the service components of the devices. The CP server 200 comprises a CP stack module 210, a description module 220, a component generation module 230 and a component lookup table module 240.

In addition, the CP server 200 can reside on any one of the devices connected to the home network and does not affect any operations of the home network devices even if the device on which the CP server 200 operates leaves the network.

The CP stack module 210 sends a search message to the devices on the home network, receives a response message from a home network device, and also parses and transmits the response message to the description module 220.

The description module 220 gains access to a device connected to the home network based on the parsed information received from the CP stack module 210 and requests a description of the home network device. Here, the description of the home network device, which is prepared using XML, includes the supplier's unique production information (e.g., model name, serial number, manufacturer's name, manufacturer's URL, etc.). Further, the description module 220 periodically requests the CP stack module 210 to check home network devices so as to examine the status of the devices residing on the home network.

The component generation module 230 generates a component, which describes the services of a device connected to the home network, based on the description of the home network device requested by the description module 220. Here, the component includes commands, operations and service responses to the respective operations for the home network device. Further, the component generation module 230 transmits the component of the home network device according to a user's control request for the home network device.

The component lookup table module 240 stores information on a component generated by the component generation module 230 in a predetermined lookup table. When a user requests services of a specific home network device, the component lookup table module 240 searches for component information of the specific home network device in the lookup table. Here, unique IDs of the home network devices are matched with their own service components in the lookup table. In response to a user's control request for a device, the lookup table is searched either by device or by service.

The CD 300 controls operations of the devices residing on the home network according to a user's control commands. Here, the user can control operations of the devices residing on the home network through the CP 100. Hereinafter, for the sake of simplicity of description, the user's control request for the devices residing on the home network will be explained as a direct control request by the CP 100 for controlling the devices residing on the home network.

Meanwhile, the CD 300 receives the search message searching for a device residing on the home network from the CP 100 and the CP server 200 and transmits location information on the relevant device.

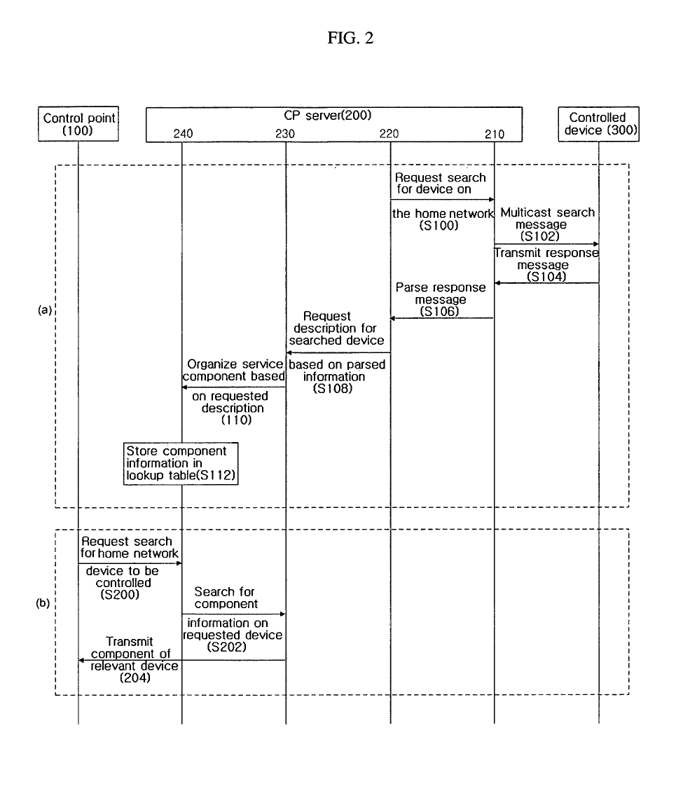

FIG. 2 is a flowchart schematically illustrating a method for the control point server system enabling efficient access to the home network devices.

FIG. 2(a) is a diagram showing a process of storing service components of devices on the home network by the CP server.

First, when the description module 220 requests the CP stack module 210 to search for a device residing on the home network (S100), the CP stack module 210 multicasts a search message searching for the device connected to the home network (S102).

Thereafter, the CD 300 receives the search message transmitted from the CP stack module 210 that intends to search for the CD 300 and transmits a response message to the CP stack module 210 (S104). Then, the CP stack module 210 parses and transmits the received response message to the description module 220 (S106). Here, the response message includes location information (e.g., URL) on the device.

Then, the description module 220 obtains access to the device residing on the home network through the parsed device information received from the CP stack module 210 and requests a description XML file that describes the kind and function of the device from the device. Thereafter, the description module 220 parses and transmits the description XML file received from the home network device to the component generation module 230 (S108). Here, the description XML file includes a supplier's unique production information (e.g., model name, serial number, manufacturer's name, manufacturer's URL, etc.).

Thereafter, the component generation module 230 generates a component describing the services of the device connected to the home network, based on the parsed description XML file received from the description module 220 (S110). Here, the component includes commands, operations, and service responses to the respective operations for the home network device.

Then, information on the generated component is transmitted to the component lookup table module 240 and registered in a predetermined lookup table (S112). That is, the component including information on the home network device residing on the home network and services provided by the home network device are stored in the lookup table. In this manner, information on all devices residing on the home network is stored in the lookup table. Accordingly, when the CP 100 requests control of a device, the lookup table module 240 searches its own lookup table to determine whether the services of the device requested by the CP 100 can be provided. Here, unique IDs of the devices are matched with their own service components in the lookup table. When there is a control request for a device by the CP 100, the lookup table is searched either by device or by service.

FIG. 2(b) is a diagram showing operations for controlling a home network device. First, the CP 100 multicasts a search message to search for a device to be controlled, which resides on the home network (S200). The component lookup table module 240 searches its own lookup table to determine whether there is information on a component of the specific device requested by the CP 100 (S202). Here, the CP 100 that controls devices residing on the home network can be understood as being a desktop or laptop computer, a PDA, a mobile phone or the like, etc.

Thereafter, the component lookup table module 240 searches for the information on the component of the specific device in its lookup table, transmits a response message to the CP 100, and requests the component generation module 230 to transmit the component of the specific device requested by the CP 100 to the CP 100.

Then, the component generation module 230 transmits the component of the specific device, according to the request by the component lookup table module 240, to the CP 100 (S204). Here, since the process of registering information on the service component of the device residing on the home network in the lookup table has been described with reference to FIG. 2(a), a detailed description thereof will be omitted.

Meanwhile, when there is a control request for a device by the CP 100, the CP server 200 and the CD 300 may respectively respond thereto. Here, since the unique ID of the device is included in the response message, the unique ID allows a home network device, which issues duplicate response messages, to be identified. Thus, there is no conflict between the CP server 200 and the CD 300.

In addition, the CP 100 may directly request the component generation module 230 to transmit the component of the device on the home network.

However, the response message transmitted from the CP server 200 to the CP 100 is in the same format as the request message multicasted by the CP 100. Table 1 below shows examples of the request and response messages mutually communicated between the CP 100 and the CP server 200.

TABLE 1

| CP | CP Server |
|---|---|
| Request for service URL | Transmission of Service URL |
| Request for presentation page URL | Transmission of Presentation page |
| | URL |
| Request for description XML URL | Transmission of XML URL |
| Request for service description | Transmission of service object |
| object | component transmission |

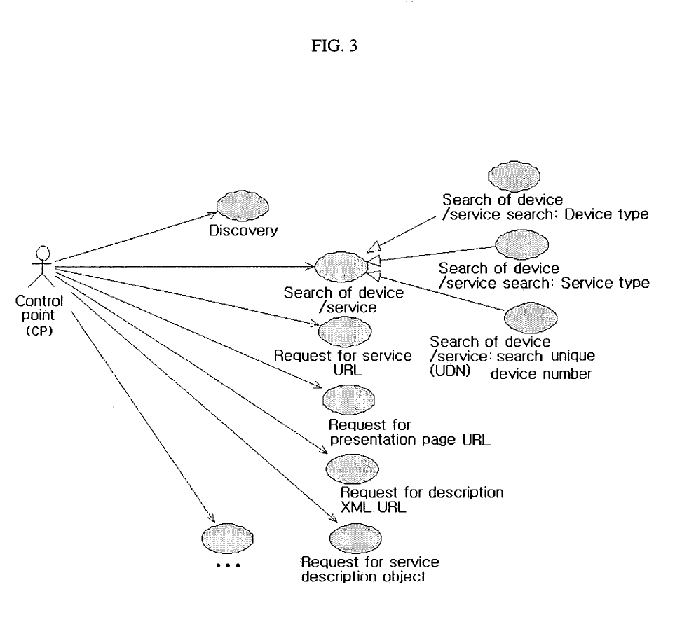

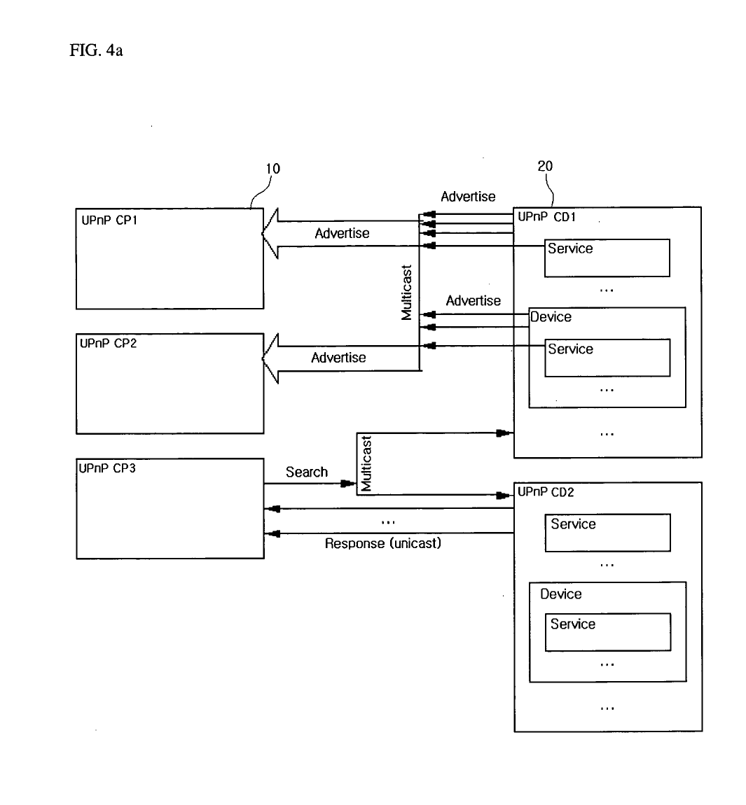

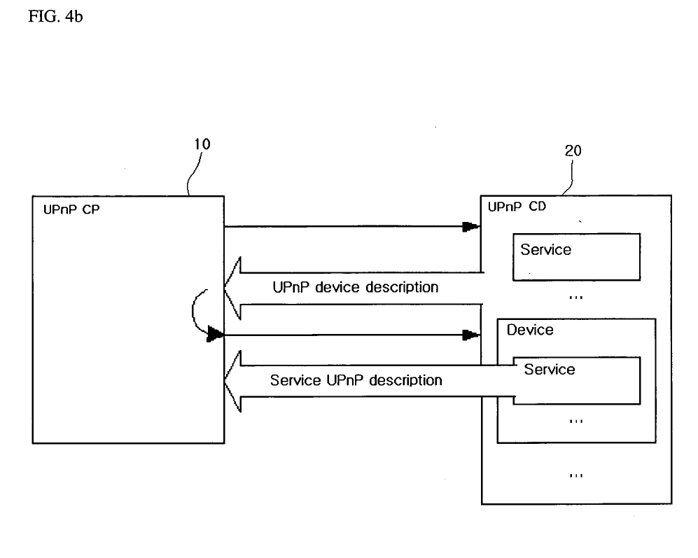

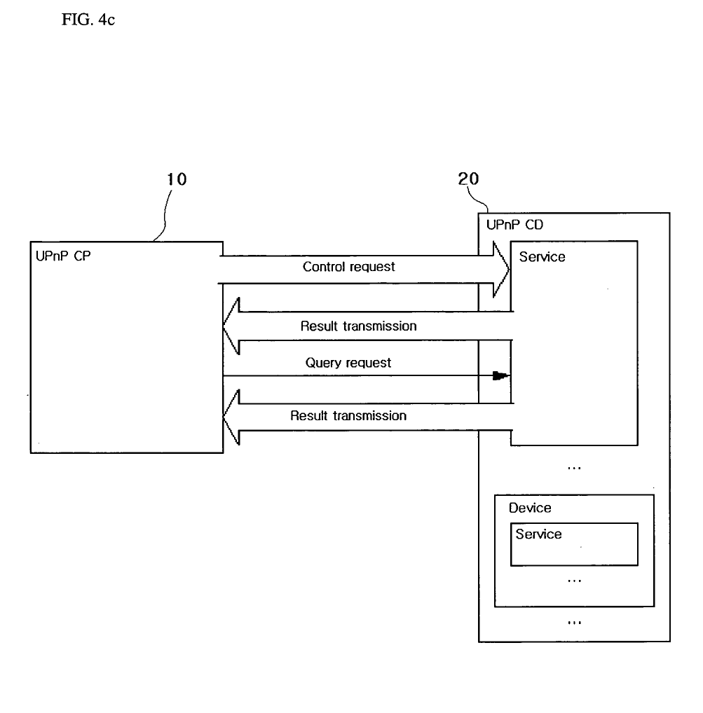

FIG. 3 is a diagram showing an example of services that the CP server can provide to the CP (user).

The CP 100 can request the CP server 200 to perform the discovery process so as to search for a specific device and services of the device. Here, according to the request by the CP 100, the CP server 200 searches for the relevant home network device based on device type, service type and unique device number (UDN) of the home network device.

Further, the CP 100 can request a service URL, a presentation page URL, a description XML URL, and a service description object of the home network device residing on the home network.

According to the present invention constructed as such, there is an advantage in that efficient access can be gained to devices on the home network by causing the CP server to beforehand perform and manage the discovery and description processes for each device, which the user wants to control, residing on the home network.

Furthermore, there is another advantage in that since the CP server containing the service components of the devices on the home network is provided, quick access can be acquired to a relevant device on the home network when the user requests control of the device.

The present invention has been described in connection with the illustrative, non-limiting embodiments thereof shown in the accompanying drawings, which are mere examples of the present invention. It can also be understood by those skilled in the art that various changes and modifications thereof can be made thereto without departing from the scope and spirit of the present invention defined by the claims. Therefore, any simple changes to the embodiments of the present invention fall within the scope of the present invention.

What is claimed is:

1. A control point server comprising one or more modules,
wherein the control point server is connected to a home network, and
wherein said one or more modules perform a discovery process and a description process for one or more devices connected to the home network to organize service components of the respective devices.

2. The control point server as claimed in claim 1, wherein the modules include:
a CP stack module for sending a search message to the devices connected to the home network and parsing a response message received from a home network device;
a description module for requesting a description of the home network device, based on the parsed information received from the CP stack module; and
a component generation module for organizing a service component that describes the services provided by the home network device based on the description requested by the description module.

3. The control point server as claimed in claim 2, wherein the modules further include a component lookup table module for storing information on the service component generated by the component generation module in a predetermined lookup table and searching for and transmitting information on a component of a specific device according to a user's control request for the specific device.

4. The control point server as claimed in claim 2, wherein the description module periodically requests the CP stack module to check a status of the devices connected to the home network.

5. The control point server as claimed in claim 2, wherein the component generation module transmits a component of a specific device according to a user's control request for the specific device.

6. A control point comprising a control unit,
wherein the control unit multicasts a search message for searching for a device connected to a home network and receives a service component of the device from a control point server that organizes the service component of the device on the home network.

7. The control point as claimed in claim 6, wherein the control unit multicasts the search message for searching for the device on the home network and controls the device by receiving information on the device from a controlled device for controlling respective devices connected to the home network.

8. The control point as claimed in claim 6, wherein when the control unit receives a first response message to the search message from the control point server and a second response message to the search message from the controlled device, the control unit does not process the later-received of the first response message and the second response message.

9. A control point server system enabling efficient access to one or more devices connected to a home network, comprising:
a control point for multicasting a search message for searching for a particular device connected to the home network and controlling the particular device; and
a control point server for organizing service components of the devices by performing a discovery process and a description process for each device connected to the home network, and transmitting a service component of the particular device according to a control request for the particular device by the control point.

10. A method for a control point server system enabling efficient access to one or more devices connected to a home network, comprising the steps of:
(a1) requesting a search for a particular device connected to the home network;
(a2) multicasting a search message for the particular device on the home network, according to the search request for the particular device;
(a3) receiving a response message to the search message, and parsing and transmitting the received response message;
(a4) requesting a description of the particular device based on information from the parsed and transmitted response message;
(a5) organizing a component that describes one or more services of the particular device based on the requested description of the particular device; and
(a6) storing information on the organized component in a predetermined lookup table.

11. The method as claimed in claim 10, wherein step (a1) further comprises the step of periodically checking a status of each device connected to the home network.

12. A method for a control point server enabling efficient access to one or more devices connected to a home network, comprising the steps of:
(b1) requesting a search for a particular device to be controlled by a control point;
(b2) searching for information on a component of the particular device in a lookup table, according to the request by the control point; and
(b3) transmitting the component of the particular device to the control point.

13. The method as claimed in claim 12, wherein step (b2) further comprises the step of directly requesting a component generation module to transmit the component of the particular device by the control point.
